(19) United States
(12) Patent Application Publication
(10) Pub. No.: US 2025/0187571 A1
(43) Pub. Date: Jun. 12, 2025

(54) LEARNING DEVICE, SQUEAL NOISE PREDICTION DEVICE, LEARNING METHOD, AND SQUEAL NOISE PREDICTION METHOD

(71) Applicants: Hyundai Motor Company, Seoul (KR); Kia Corporation, Seoul (KR)

(72) Inventors: Sung Hyun Cho, Yongin-si (KR); Sung Ho Kim, Seoul (KR); Jung Ro Yoon, Seongnam-si (KR); Jeong Kyu Kim, Suwon-si (KR); Yoon Cheol Kim, Suwon-si (KR); Kyung Rok Choi, Suwon-si (KR)

(21) Appl. No.: 18/629,387

(22) Filed: Apr. 8, 2024

(30) Foreign Application Priority Data
Dec. 12, 2023 (KR) 10-2023-0180167

(51) Int. Cl. B60T 8/174; B60T 17/22

(52) U.S. Cl. CPC B60T 8/174; B60T 17/221

(57) ABSTRACT

A learning device can include one or more processors, and a storage medium storing computer-readable instructions that enable the one or more processors to preprocess one of or any combination of first raw data extracted from a braking device of a vehicle, second raw data including wheel data associated with a wheel of the vehicle, and third raw data measured from an external sensor of the vehicle, to obtain training input data at a target time point at which the braking device operates, apply the training input data and target data corresponding to squeal noise generated by the training input data, to a squeal noise prediction model to obtain temporary output data, and train the squeal noise prediction model, based on a first loss value obtained by applying the temporary output data and the target data to a first loss function associated with regression.

### CROSS-REFERENCE TO RELATED APPLICATIONS

This application claims the benefit of priority to Korean Patent Application No. 10-2023-0180167, filed in the Korean Intellectual Property Office on Dec. 12, 2023, the entire contents of which are incorporated herein by reference.

### TECHNICAL FIELD

The present disclosure relates to a learning device for predicting squeal noise in a vehicle.

### BACKGROUND

A braking device of a vehicle is a device that converts rotational kinetic energy of the wheel of the vehicle into thermal energy through friction between a disk and a pad included in the braking device. Therefore, when resonance occurs in the braking device due to exciting energy between the disk and the pad and when the resonance is greater than the damping limit of the system, noise may be generated.

Herein, when the noise corresponds to the frequency range of 1 KHz to 16 KHz, it is squeal noise. This causes great dissatisfaction of users as the sound is unpleasant. However, although the vehicle is designed to prevent squeal noise of the braking device in the stage of developing the vehicle, because wear occurs on the disk and the pad included in the braking device over time and the vibration characteristic of the braking device also changes, noise that is not generated in the stage of developing the vehicle may be generated.

To address such a problem, there is a need to develop a technology for predicting squeal noise and a technology for reducing the predicted squeal noise.

### SUMMARY

The present disclosure relates to a learning device, a squeal noise prediction device, a learning method, and a squeal noise prediction method, and more particularly, relates to technologies for predicting squeal noise.

Some embodiments of the present disclosure can solve the above-mentioned problems occurring in the prior art while advantages achieved by the prior art are maintained intact.

An embodiment of the present disclosure can provide a learning device for training a squeal noise prediction model based on training input data generated through preprocessing of first raw data, second raw data, and third raw data to reflect a relation between a rapid change in friction coefficient between a disk and a pad and a torque estimate in the squeal noise prediction model, a squeal noise prediction device, a learning method, and a squeal noise prediction method.

An embodiment of the present disclosure can provide a learning device for training a squeal noise prediction model based on a first loss function associated with regression or a second loss function associated with classification to increase the satisfaction of a user by use of the squeal noise prediction model with better performance than training the squeal noise prediction model using one loss function, a squeal noise prediction device, a learning method, and a squeal noise prediction method.

An embodiment of the present disclosure can provide a learning device for performing online learning of a squeal noise prediction model using the obtained data after training the squeal noise prediction model to reduce squeal noise capable of being generated from a braking device that is aging according to a usage condition of a user, a squeal noise prediction device, a learning method, and a squeal noise prediction method.

Technical problems to be solved by some embodiments of the present disclosure are not necessarily limited to the aforementioned problems, and solutions provided by an embodiment to other technical problems not mentioned herein can be clearly understood from the following description by those skilled in the art to which the present disclosure pertains.

According to an embodiment of the present disclosure, a learning device may include a memory storing computer-executable instructions and at least one processor that accesses the memory and executes the instructions. The at least one processor may preprocess at least one of first raw data extracted from a braking device of a vehicle, second raw data including pieces of data associated with a wheel of the vehicle, third raw data measured from an external sensor of the vehicle, or any combination thereof, to obtain training input data, at a target time point when the braking device operates, may apply the training input data and target data corresponding to squeal noise generated by the training input data to a squeal noise prediction model to obtain temporary output data, and may train the squeal noise prediction model, based on a first loss value obtained by applying the temporary output data and the target data to a first loss function associated with regression.

In an embodiment, the at least one processor may generate the first raw data including at least one of oil pressure data associated with oil pressure applied to the braking device, disk temperature data, torque data associated with a torque applied to a disk included in the braking device, or any combination thereof, may generate the second raw data, including at least one of wheel speed data associated with a speed of the wheel or rolling circumference data of a tire combined with the wheel, or any combination thereof, at the target time point, and may generate the third raw data, including at least one of outside air temperature data from the external sensor or humidity data from the external sensor, or any combination thereof, at the target time point.

In an embodiment, the at least one processor may generate first sub-input data including the square of the disk temperature data and the square of the wheel speed data, may generate second sub-input data including a change between the wheel speed data and wheel speed data at a subsequent time point subsequent to the target time point, a change between the disk temperature data and disk temperature data at the subsequent time point, a change between the oil pressure data and oil pressure data at the subsequent time point, and a change between the torque data and torque data at the subsequent time point, may generate third sub-input data including first torque estimation data generated based on the change between the wheel speed data and the wheel speed data at the subsequent time point and second torque estimation data generated based on the first torque estimation data and the disk temperature data, and may bind the first sub-input data, the second sub-input data, and the third sub-input data to obtain the training input data.

In an embodiment, the at least one processor may train the squeal noise prediction model, based on a second loss value obtained by applying the temporary output data and the target data to a second loss function associated with classification.

In an embodiment, the at least one processor may determine a classification class of the training input data, based on a comparison between the temporary output data and a predetermined threshold, and may train the squeal noise prediction model, based on a second loss value obtained by applying the classification class and the target data to the second loss function.

According to an embodiment of the present disclosure, a squeal noise prediction device may include a memory storing computer-executable instructions and at least one processor that accesses the memory and executes the instructions. The at least one processor may apply at least one of data extracted from a braking device of a vehicle, data corresponding to a wheel of the vehicle, or data measured from an external sensor of the vehicle, or any combination thereof to a trained squeal noise prediction model to obtain an expected probability indicating a probability that squeal noise of the braking device will be generated, may determine that the squeal noise is generated in the braking device, based on that the expected probability is greater than a predetermined threshold, and may determine an oil pressure control mode of the vehicle, based on at least one of a stability control mode of the vehicle, an outside air temperature measured from the external sensor, or a driving time of the vehicle, or any combination thereof, based on that the squeal noise is generated in the braking device.

In an embodiment, the at least one processor may determine the oil pressure control mode, based on a first sub-condition for comparing the outside air temperature with a first threshold and a second sub-condition for comparing the driving time with a second threshold, based on that the stability control mode is deactivated.

In an embodiment, the at least one processor may determine the oil pressure control mode as a first oil pressure control mode, based on that the first sub-condition is met and the second sub-condition is met, may determine the oil pressure control mode as a second oil pressure control mode, based on that the first sub-condition is met and the second sub-condition is not met, and may determine the oil pressure control mode as a third oil pressure control mode, based on that the first sub-condition is not met and the second sub-condition is not met.

In an embodiment, the at least one processor may determine a torque compensating amount corresponding to the determined oil pressure control mode, based on an oil pressure decrease amount corresponding to the determined oil pressure control mode, a friction coefficient between a disk and a pad included in the braking device, and a piston area of the disk included in the braking device.

In an embodiment, the at least one processor may apply the torque compensating amount to at least one of a motor for generating a braking force through regenerative braking in the vehicle, a motor for generating a braking force by use of an electronic parking brake of the vehicle, or a transmission for generating a braking force by use of an engine brake of the vehicle in the vehicle, or any combination thereof to generate a braking force lost by the oil pressure decrease amount to brake the vehicle.

According to an embodiment of the present disclosure, a learning method may include preprocessing at least one of first raw data extracted from a braking device of a vehicle, second raw data including pieces of data associated with a wheel of the vehicle, third raw data measured from an external sensor of the vehicle, or any combination thereof to obtain training input data, at a target time point when the braking device operates, applying the training input data and target data corresponding to squeal noise generated by the training input data to a squeal noise prediction model to obtain temporary output data, and training the squeal noise prediction model, based on a first loss value obtained by applying the temporary output data and the target data to a first loss function associated with regression.

In an embodiment, the obtaining of the training input data may include generating the first raw data including at least one of oil pressure data associated with oil pressure applied to the braking device, disk temperature data, torque data associated with a torque applied to a disk included in the braking device, or any combination thereof, generating the second raw data, including at least one of wheel speed data associated with a speed of the wheel or rolling circumference data of a tire combined with the wheel, or any combination thereof, at the target time point, and generating the third raw data, including at least one of outside air temperature data from the external sensor or humidity data from the external sensor, or any combination thereof, at the target time point.

In an embodiment, the learning method may further include generating first sub-input data including the square of the disk temperature data and the square of the wheel speed data, generating second sub-input data including a change between the wheel speed data and wheel speed data at a subsequent time point subsequent to the target time point, a change between the disk temperature data and disk temperature data at the subsequent time point, a change between the oil pressure data and oil pressure data at the subsequent time point, and a change between the torque data and torque data at the subsequent time point, generating a third sub-input data including first torque estimation data generated based on the change between the wheel speed data and the wheel speed data at the subsequent time point and second torque estimation data generated based on the first torque estimation data and the disk temperature data, and binding the first sub-input data, the second sub-input data, and the third sub-input data to obtain the training input data.

In an embodiment, the training of the squeal noise prediction model may include training the squeal noise prediction model, based on a second loss value obtained by applying the temporary output data and the target data to a second loss function associated with classification.

In an embodiment, the training of the squeal noise prediction model may include determining a classification class of the training input data, based on a comparison between the temporary output data and a predetermined threshold, and training the squeal noise prediction model, based on a second loss value obtained by applying the classification class and the target data to the second loss function.

According to an embodiment of the present disclosure, a squeal noise prediction method may include applying at least one of data extracted from a braking device of a vehicle, data corresponding to a wheel of the vehicle, or data measured from an external sensor of the vehicle, or any combination thereof to a trained squeal noise prediction model to obtain an expected probability indicating a probability that squeal noise of the braking device will be generated, determining that the squeal noise is generated in the braking device, based on that the expected probability is greater than a predetermined threshold, and determining an oil pressure control mode of the vehicle, based on at least one of a stability control mode of the vehicle, an outside air temperature measured from the external sensor, a driving time of the vehicle, or any combination thereof, based on that the squeal noise is generated in the braking device.

In an embodiment, the determining of the oil pressure control mode of the vehicle may include determining the oil pressure control mode, based on a first sub-condition for comparing the outside air temperature with a first threshold and a second sub-condition for comparing the driving time with a second threshold, based on that the stability control mode is deactivated.

In an embodiment, the determining of the oil pressure control mode of the vehicle may include determining the oil pressure control mode as a first oil pressure control mode, based on that the first sub-condition is met and the second sub-condition is met, determining the oil pressure control mode as a second oil pressure control mode, based on that the first sub-condition is met and the second sub-condition is not met, and determining the oil pressure control mode as a third oil pressure control mode, based on that the first sub-condition is not met and the second sub-condition is not met.

In an embodiment, the squeal noise prediction method may further include determining a torque compensating amount corresponding to the determined oil pressure control mode, based on an oil pressure decrease amount corresponding to the determined oil pressure control mode, a friction coefficient between a disk and a pad included in the braking device, and a piston area of the disk included in the braking device.

In an embodiment, the squeal noise prediction method may further include applying the torque compensating amount to at least one of a motor for generating a braking force through regenerative braking in the vehicle, a motor for generating a braking force by use of an electronic parking brake of the vehicle, a transmission for generating a braking force by use of an engine brake of the vehicle in the vehicle, or any combination thereof to generate a braking force lost by the oil pressure decrease amount to brake the vehicle.

### BRIEF DESCRIPTION OF THE DRAWINGS

The above and other features and advantages of the present disclosure can be more apparent from the following detailed description taken in conjunction with the accompanying drawings, in which:

FIG. 1 is a drawing illustrating a learning device for training a squeal noise prediction model according to an embodiment of the present disclosure;

FIG. 2 is a flowchart for describing a method for training a squeal noise prediction model according to an embodiment of the present disclosure;

FIG. 3 is a drawing illustrating a method for obtaining pieces of data for training a squeal noise prediction model, in a learning device according to an embodiment of the present disclosure;

FIG. 4 is a drawing for describing training input data, in a learning device according to an embodiment of the present disclosure;

FIG. 5 is a flowchart for describing a method for predicting squeal noise by use of a trained squeal noise prediction model, in a squeal noise prediction device according to an embodiment of the present disclosure;

FIG. 6 is a flowchart for describing a method for determining a torque compensating amount, in a squeal noise prediction device according to an embodiment of the present disclosure;

FIG. 7 is a flowchart for describing a method for determining an oil pressure control mode, in a squeal noise prediction device according to an embodiment of the present disclosure;

FIG. 8 is a flowchart for describing a method for braking a vehicle, in a squeal noise prediction device according to an embodiment of the present disclosure; and

FIG. 9 is a drawing illustrating a computing system that can be associated with a learning device, a squeal noise prediction device, a learning method, and a squeal noise prediction method according to an embodiment of the present disclosure.

With regard to description of drawings, same or similar denotations may be used for same or similar components.

### DETAILED DESCRIPTION OF ILLUSTRATIVE EMBODIMENTS

Hereinafter, some example embodiments of the present disclosure will be described in detail with reference to the drawings. In adding reference numerals to the components of each drawing, it can be noted that an identical component can be designated by an identical numerals even when displayed on other drawings. In addition, a detailed description of well-known features or functions can be omitted to not unnecessarily obscure the gist of the present disclosure. Hereinafter, various example embodiments of the present disclosure may be described with reference to the accompanying drawings. However, it can be understood that the example embodiments are not intended to necessarily limit the present disclosure to specific implementation forms and an embodiment can include various modifications, equivalents, and/or alternatives of other embodiments of the present disclosure. With regard to the description of drawings, similar components may be marked by similar reference numerals.

In the present disclosure, the terms “first”, “second”, “A”, “B”, “(a)”, “(b)”, and the like, may be used herein. Such terms can be only used to distinguish one component from another component, but do not necessarily limit the corresponding components irrespective of the order or priority of the corresponding components. Furthermore, unless otherwise defined, terms including technical and scientific terms used herein can have a same meaning as being generally understood by those skilled in the art to which the present disclosure pertains. Such terms as those defined in a generally used dictionary can be interpreted as having meanings equal to the contextual meanings in the relevant field of art. For example, the terms, such as “first”, “second”, “1st”, “2nd”, or the like used in the present disclosure may be used to refer to various components regardless of the order and/or the priority and to distinguish one component from another component, but do not necessarily limit the components. For example, a first user device and a second user device indicate different user devices, irrespective of the order and/or priority. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It can be understood that when a component (e.g., a component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it can be understood that there is no intervening component (e.g., a third component).

According to the situation, the expression “configured to” used in the present disclosure may be used interchangeably with, for example, the expression “suitable for”, “having the capacity to”, “designed to”, “adapted to”, “made to”, or “capable of”.

The term “configured to” must not mean only “specifically designed to” in hardware. Instead, the expression “a device configured to” can mean that the device is “capable of” operating together with another device or other parts. For example, a “processor configured to perform A, B, and C” may mean a generic-purpose processor (e.g., a central processing unit (CPU) or an application processor) that may perform corresponding operations by executing one or more software programs that store a dedicated processor (e.g., an embedded processor) for performing a corresponding operation or a memory device. The terms of a singular form may include plural forms unless the context clearly indicates otherwise. All the terms used herein, which include technical or scientific terms, may have the same meaning that is generally understood by a person skilled in the art described in the present disclosure. It will be further understood that terms, which are defined in a dictionary and commonly used, should also be interpreted as is customary in the relevant related art and not in an idealized or overly formal detect unless expressly so defined herein in various embodiments of the present disclosure. In some cases, even though terms are terms which are defined in the specification, they may not be interpreted to exclude embodiments of the present disclosure.

In the present disclosure, the expressions “A or B”, “at least one of A or/and B”, or “one or more of A or/and B”, and the like, may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. Particularly, the phrase such as “at least one of A, B, C, or any combination thereof” may include more than one “A”, one “A”, more than one “B”, one “B”, more than one “C”, or one “C”, or “AB” or “ABC”, which is a combination thereof, for example.

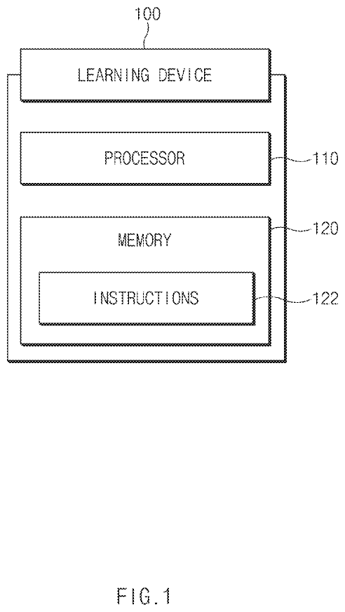

Hereinafter, some example embodiments of the present disclosure will be described in detail with reference to FIGS. 1 to 9.

FIG. 1 is a drawing illustrating a learning device for training a squeal noise prediction model according to an embodiment of the present disclosure.

A learning device 100 according to an embodiment may include a processor 110 and a memory 120 including instructions 122, either or both of which may be in plural or may include plural components thereof.

The learning device 100 may indicate a device that trains the squeal noise prediction model. For example, the learning device 100 may perform the following operations to train the squeal noise prediction model. The learning device 100 may preprocess pieces of raw data received from a braking device of a vehicle, a wheel of the vehicle, and an external sensor of the vehicle to obtain training input data. The learning device 100 may apply the training input data and target data to the squeal noise prediction model to obtain temporary output data. The learning device 100 may train the squeal noise prediction model, based on a loss function obtained by applying the temporary output data and the target data to a loss function.

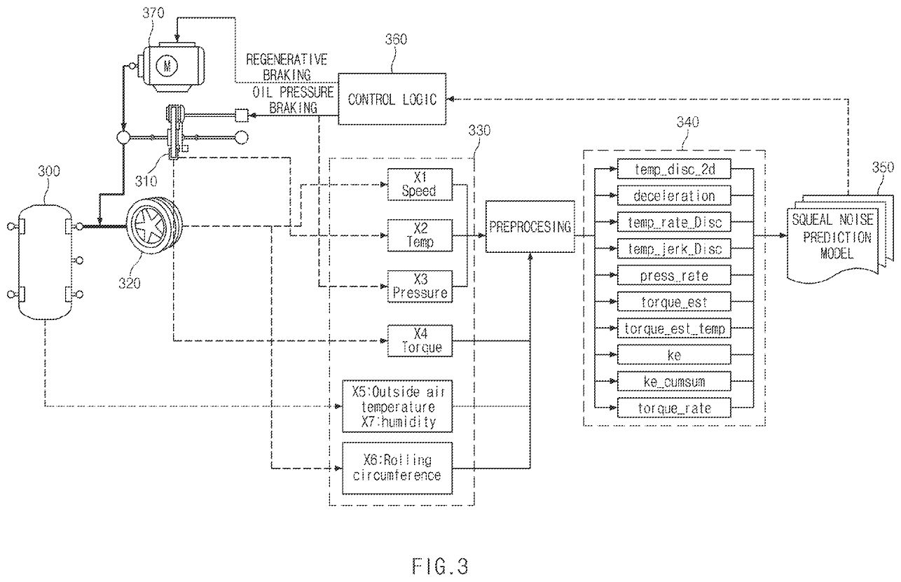

The learning device 100 may preprocess at least one of first raw data extracted from the braking device of the vehicle, second raw data including pieces of data associated with the wheel of the vehicle, third raw data measured from the external sensor of the vehicle, or any combination thereof, to obtain the training input data, at a target time point when the braking device operates. For example, the target time point may indicate a specific time point at which a braking signal is input to the braking device. The first raw data may include oil pressure data, disk temperature data, and torque data. The second raw data may include wheel speed data and rolling circumference data. The third raw data may include outside air temperature data and humidity data. A description will be given below of a detailed method for generating the first to third raw data with reference to FIG. 3.

The learning device 100 may apply the training input data and the target data corresponding to squeal noise generated by the training input data to the squeal noise prediction model to obtain the temporary output data. For example, the temporary output data may be an output generated in response to the training input data by the squeal noise prediction model while trained.

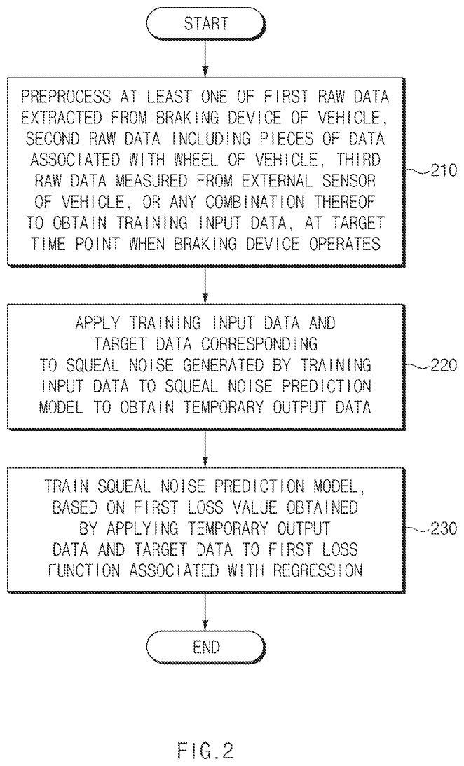

The learning device 100 may train the squeal noise prediction model, based on a loss value obtained by applying the temporary output data and the target data to a first loss function associated with regression or a second loss function associated with classification. For example, the learning device 100 may apply the temporary output data and the target data to the first loss function to obtain a first loss value. Otherwise, the learning device 100 may compare the temporary output data with the target data to determine a classification class of the training input data. The learning device 100 may apply the classification class, the temporary output data, and the target data to the second loss function to obtain a second loss value. The learning device 100 may train the squeal noise prediction model, based on the first loss value or the second loss value. A detailed description associated with it will be given below with reference to FIG. 2.

The processor 110 may execute software and may control at least one other component (e.g., a hardware or software component) connected with the processor 110. In addition, the processor 110 may perform a variety of data processing or calculation. For example, the processor 110 may store the first raw data, the second raw data, the third raw data, and the like in the memory 120. For reference, the processor 110 may perform all operations performed by the learning device 100. Therefore, for convenience of description in the specification, the operation performed by the learning device 100 is mainly described as an operation performed by the processor 110.

Furthermore, for convenience of description in the specification, the processor 110 is mainly described as, but not limited to, one processor. For example, the learning device 100 may include at least one processor. Each of the at least one processor may perform all operations associated with training the squeal noise prediction model.

The memory 120 may temporarily and/or permanently store various pieces of data and/or information required to train the squeal noise prediction model. For example, the memory 120 may store the first raw data, the second raw data, the third raw data, and the like.

FIG. 2 is a flowchart for describing a method for training a squeal noise prediction model according to an embodiment of the present disclosure.

In operation 210, a learning device (e.g., a learning device 100 of FIG. 1) according to an embodiment may preprocess at least one of first raw data extracted from a braking device of a vehicle, second raw data including pieces of data associated with a wheel of the vehicle, third raw data measured from an external sensor of the vehicle, or any combination thereof, to obtain training input data, at a target time point when the braking device operates.

In operation 220, the learning device may apply the training input data and target data corresponding to squeal noise generated by the training input data to a squeal noise prediction model to obtain temporary output data. For example, the squeal noise prediction model may indicate a model that is trained and/or being trained by use of machine learning and may be a trained machine learning model that outputs a training output (e.g., a squeal noise prediction probability) from a training input (e.g., the training input data).

In operation 230, the learning device may train the squeal noise prediction model, based on a first loss value obtained by applying the temporary output data and the target data to a first loss function associated with regression. However, the method for training the squeal noise prediction model is not limited thereto. For example, the learning device may train the squeal noise prediction model, based on a second loss value obtained by applying the temporary output data and the target data to a second loss function associated with classification.

For example, the squeal noise prediction model may include a neural network. The neural network may include a plurality of layers. Each layer may include a plurality of nodes. The node may have a node value determined based on an activation function. A node of any layer may be connected with a node (e.g., another node) of another layer through a link (e.g., a connection edge) with a connection weight. The node value of the node may be propagated to other nodes through the link. In an inference operation of the neural network, node values may be forward propagated in the direction of a next layer from a previous layer.

Illustratively, the forward propagation calculation in the squeal noise prediction model may indicate calculation of propagating a node value based on input data, in the direction facing the output layer from the input layer of the squeal noise prediction model. In other words, a node value of the node may be propagated (e.g., forward propagated) to a node (e.g., a next node) of a next layer connected with the node through the connection edge. For example, the node may receive a value weighted by the connection weight from a previous node (e.g., a plurality of nodes) connected through the connection edge.

The node value of the node may be determined based on applying an activation function to the sum (e.g., weighted sum) of weighted values received from previous nodes. The parameter of the neural network may illustratively include the above-mentioned connection weight. The parameter of the neural network may be updated to change in a direction in which the value of a loss function (e.g., the first loss function or the second loss function) is targeted. A detailed description associated with the loss function will be given below with reference to FIG. 3.

The machine learning model (e.g. the trained squeal noise prediction model) may be generated by use of machine learning. A learning algorithm may include, for example, but is not limited to, supervised learning, unsupervised learning, semi-supervised learning, or reinforcement learning.

The learning algorithm may include a machine learning system including an algorithm for performing training from data. Such an algorithm may include a function for operating a computer without artificial intelligence (AI) or a program from the outside, which is automatically learned by the computer without automatic reasoning, automatic adaptation, automatic determination, automatic learning, an external program or the artificial intelligence (AI), or any combination thereof, for example. The machine learning may include classification, regression analysis, feature learning, online learning, autonomous learning, supervised learning, cluster analysis, dimension reduction, structure prediction, abnormal behavior detection, a neural network, or any combination thereof, for example.

The machine learning model may include a plurality of artificial neural network layers. In detail, the trained squeal noise prediction model may include a shared layer including at least one convolution operation and a plurality of classifier layers connected with the shared layer. An artificial neural network may be, but is not limited to, a combination of at least one of a deep neural network (DNN), a convolutional neural network (CNN), a U-net for image segmentation (U-net), a recurrent neural network (RNN), a restricted Boltzmann machine (RBM), a deep belief network (DBN), a bidirectional recurrent deep neural network (BRDNN), or deep Q-networks, or any combination thereof, for example. For example, the trained squeal noise prediction model may be a mixed effect reflection machine learning model. Herein, the mixed effect reflection machine learning model may include a regression methodology for outputting a squeal noise prediction probability from input data and may include a methodology considering a distribution-based random effect. Illustratively, the mixed effect reflection machine learning model may include linear regression, logistic regression, a classification and regression tree algorithm, a support vector machine (SVM), Naive Bayes, K-nearest neighbor, a random forest algorithm, XGBoost, LightGBM, mixed effects random forests (MERF), mixed effects light gradient boosting (MELGB), or the like.

FIG. 3 is a drawing illustrating a method for obtaining pieces of data for training a squeal noise prediction model, in a learning device according to an embodiment of the present disclosure.

A learning device (e.g., a learning device 100 of FIG. 1) according to an embodiment may preprocess a raw dataset 330 received from a braking device 310 of a vehicle 300, a wheel 320 of the vehicle 300, and an external sensor of the vehicle 300 to obtain training input data 340, at a target time when the braking device 310 operates.

The learning device may generate first raw data including at least one of oil pressure data (e.g., shown as “X3 Pressure” in FIG. 3) associated with oil pressure applied to the braking device 310, disk temperature data (e.g., shown as “X2 Temp” in FIG. 3), torque data (e.g., shown as “X4 Torque” in FIG. 3), or any combination thereof.

The learning device may generate second raw data, including at least one of wheel speed data (e.g., shown as “X1 Speed” in FIG. 3) associated with a speed of the wheel 320 or rolling circumference data (e.g., shown as “X6 rolling circumference” in FIG. 3) of a tire combined with the wheel 320, or any combination thereof, at the target time point.

The learning device may generate third raw data, including at least one of outside air temperature data (e.g., shown as “X5 outside air temperature” in FIG. 3) from an external sensor of the vehicle 300 or humidity data (e.g., shown as “X7 humidity” in FIG. 3) from the external sensor of the vehicle 300, or any combination thereof, at the target time point.

The learning device may preprocess the raw dataset 330 including the first raw data, the second raw data, and the third raw data to obtain the training input data 340. For example, the learning device may bind a plurality of pieces of sub-input data generated by preprocessing the raw dataset 330 to obtain the training input data 340.

The learning device may generate first sub-input data including the square of the disk temperature data (i.e., the process of preprocessing the disk temperature data, same as below) and the square of the wheel speed data.

The learning device may generate second sub-input data including a change between the wheel speed data and wheel speed data at a subsequent time point subsequent to the target time point, a change between the disk temperature data and disk temperature data at the subsequent time point, a change between the oil pressure data and oil pressure data at the subsequent time point, and a change between the torque data and torque data at the subsequent time point.

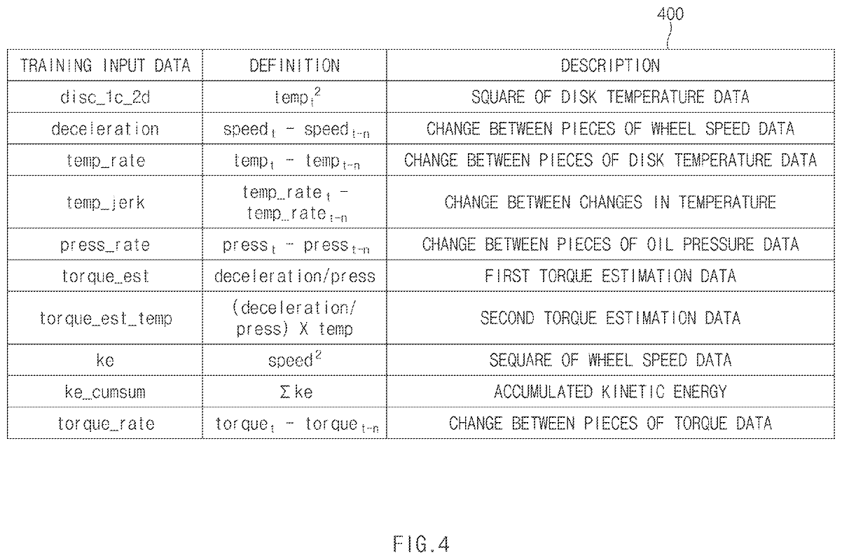

The learning device may generate third sub-input data including first torque estimation data generated based on the change between the wheel speed data and the wheel speed data at the subsequent time point subsequent to the target time point and second torque estimation data generated based on the first torque estimation data and the disk temperature data. A detailed description about the first sub-input data, the second sub-input data, and the third sub-input data will be described below with reference to FIG. 4.

The learning device may bind the first sub-input data, the second sub-input data, and the third sub-input data to obtain the training input data 340. However, the method for obtaining the training input data 340 is not limited thereto. For example, the learning device may obtain the training input data 340 through preprocessing of torque wheel raw data (not shown) obtained based on at least one of a torque applied to the braking device 310, a torque applied to the wheel 320, a torque applied to a regenerative braking motor 370, or any combination thereof.

In detail, the learning device may bind the first sub-input data, the second sub-input data, and the third sub-input data to obtain first training input data (not shown). The learning device may obtain second training input data (not shown) through preprocessing of the torque wheel raw data. The learning device may apply the first training input data to the squeal noise prediction model 350 to perform training of the squeal noise prediction model 350. The learning device may apply the second training input data to the squeal noise prediction model 350 to perform training of the squeal noise prediction model 350, based on that a time for the above-mentioned training is greater than a predetermined training time.

The learning device may train the squeal noise prediction model 350 using the first training input data to reflect a relation between pieces of data obtained from the vehicle 300 and squeal noise in the squeal noise prediction model 350. Thereafter, the learning device may train the squeal noise prediction model 350 using the first training input data to reflect a relation between pieces of torque data obtained from the vehicle 300 and squeal noise in the squeal noise prediction model 350.

The learning device may apply the obtained training input data 340 and target data corresponding to squeal noise generated by the training input data 340 to the squeal noise prediction model 350. The learning device may apply temporary output data obtained from the squeal noise prediction model 350 and the target data to a loss function to train the squeal noise prediction model 350.

The learning device may use a first loss function or a second loss function to train the squeal noise prediction model 350. For example, the first loss function may be a loss function associated with regression, which may include a mean absolute error (MAE), a mean squared error (MSE), a root mean square error (RMS), or the like. The second loss function may be a loss function associated with classification, which may include binary cross-entropy, categorical cross-entropy, or the like, for example. The learning device may use at least one of the first loss function or the second loss function to train the squeal noise prediction model 350, based on a condition predetermined by a user.

In detail, when the second loss function is used to train the squeal noise prediction model 350, the learning device may determine a classification class of the training input data 340, based on a comparison between the temporary output data and a predetermined threshold. The learning device may train the squeal noise prediction model 350, based on a loss value obtained by applying the classification class and the target data to the second loss function.

The classification class of the training input data 340 may be determined by Table 1 below.

TABLE 1

| Classification class | Contents |
|---|---|
| 0 | Determine that noise is not generated, |
| | Predict noise of 25% or less of noise generation |
| | determination dB |
| 1 | Determine that noise is not generated, |
| | Predict noise of 50% or less of noise generation |
| | determination dB |
| 2 | Determine that noise is not generated, |
| | Predict noise of 75% or less of noise generation |
| | determination dB |
| 3 | Determine that noise is generated, |
| | Predict noise of 125% or less of noise generation |
| | determination dB |
| 4 | Determine that noise is generated, |
| | Predict noise of 150% or less of noise generation |
| | determination dB |

Herein, that the classification class is “o” may be that the training input data 340 has a class in which squeal noise is not generated, which may mean that noise of 25% or less of squeal noise generation determination dB is predicted. That the classification class is “1” may be that the training input data 340 has the class in which the squeal noise is not generated, which may mean that noise of 50% or less of the squeal noise generation determination dB is predicted. That the classification class is “2” may be that the training input data 340 has the class in which the squeal noise is not generated, which may mean that noise of 75% or less of the squeal noise generation determination dB is predicted. That the classification class is “3” may be that the training input data 340 has a class in which the squeal noise is generated, which may mean that noise of 125% or less of the squeal noise generation determination dB is predicted. That the classification class is “4” may be that the training input data 340 has the class in which the squeal noise is generated, which may mean that noise of 150% or less of the squeal noise generation determination dB is predicted.

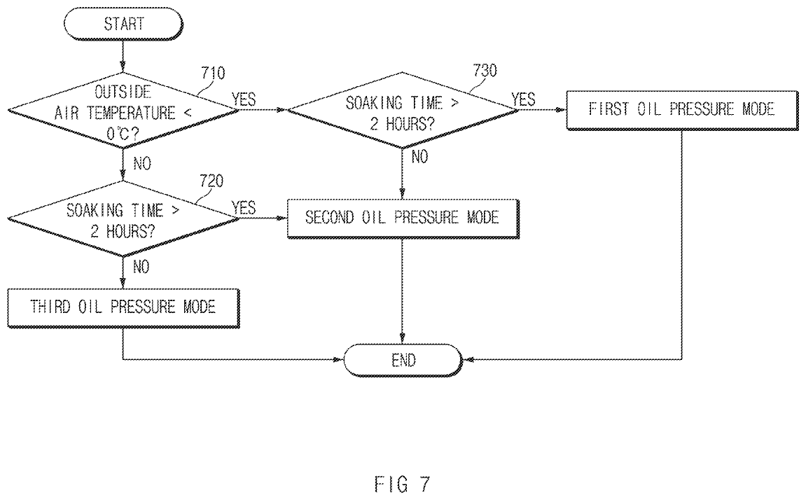

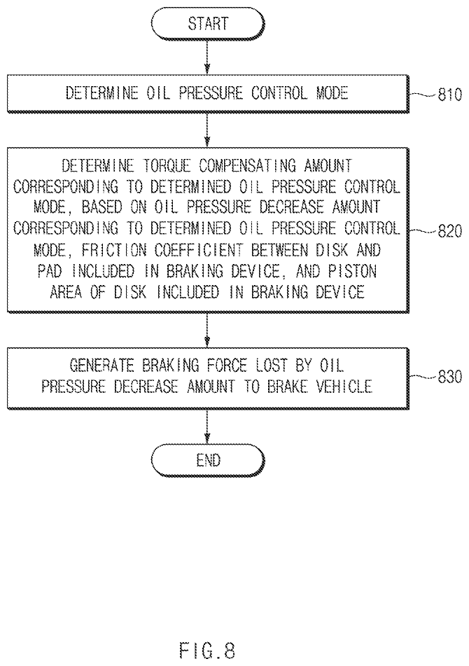

The learning device may apply the result output from the squeal noise prediction model 350 trained by at least one of the first loss function or the second loss function (e.g., an expected probability of squeal noise or whether squeal noise is generated) to control logic 360. The learning device may apply the output result to the control logic 360, thus adjusting and/or correcting oil pressure braking in the braking device 310 or adjusting and/or correcting regenerative braking in a regenerative braking motor. A detailed description of it will be described below with reference to FIGS. 7 to 8.

FIG. 4 is a drawing for describing training input data, in a learning device according to an embodiment of the present disclosure.

Referring to FIG. 4, training input data 400 may include pieces of data obtained by preprocessing pieces of raw data received from a braking device of a vehicle, a wheel of the vehicle, and an external sensor of the vehicle.

The training input data 400 may include the following variables. For example, “disc_1c_2d” may refer to the square of disk temperature data. Herein, a value calculated by squaring the disk temperature data may include a relationship between a width in which the temperature of a disk changes and a fluctuation width of a friction coefficient between the disk and a pad.

In the training input data 400, “deceleration” may refer to a change (e.g., which may indicate a difference, hereinafter referred to as a “change”) between wheel speed data at a “t” time point and wheel speed data at a “t-n” time point. For example, the change between the pieces of wheel speed data may include deceleration that has a linear relationship with the friction coefficient between the disk and the pad, based on a linear relationship between torque and deceleration.

In the training input data 400, “temp_rate” may be a change in disk temperature data, which may refer to a change between disk temperature data at the “t” time point and disk temperature data at the “t-n” time point. For example, the change between the pieces of disk temperature data may include a relationship between a width in which the temperature of the disk changes and a fluctuation width of a friction coefficient between the disk and the pad.

In the training input data 400, “temp_jerk” may be a change between a change in disk temperature data at the “t” time point and a change in disk temperature data at the “t-n” time. For example, the change between the changes in the disk temperature data may include a relationship of a change in the changed target, as well as the change in disk temperature data.

In the training input data 400, “press_rate” may be a change between oil pressure data at the “t” time point and oil pressure data at the “t-n” time. For example, the change between the pieces of oil pressure data may include a physical phenomenon in which the friction coefficient between the disk and the pad is influenced by pressure.

In the training input data 400, “torque_est” may be first torque estimation data, which may refer to a ratio between a change in wheel speed data and oil pressure data. For example, the first torque estimation data may indicate data generated based on a feature of deceleration with a linear relationship with torque.

In the training input data 400, “torque_est_temp” may be second torque estimation data, which may refer to the result of multiplying the first torque estimation data by the disk temperature data. For example, the second torque estimation data may indicate data generated based on a feature of reflecting influence of temperature in the feature of deceleration with the linear relationship with torque.

In the training input data 400, “ke” may be the kinetic energy of a vehicle, which may refer to the square of wheel speed data. In the training input data 400, “ke_cumsum” may be a value in which the kinetic energy of the vehicle is accumulated, which may refer to the sum of the kinetic energy of the vehicle during a predetermined duration.

In the training input data 400, “torque_rate” may be a change between torque data at the “t” time point and torque data at the “t-n” time. Herein, the torque data at the “t” time point and the torque data at the “t-n” time may indicate first torque data at the “t” time point and first torque data at the “t-n” time or second torque data at the “t” time point and second torque data at the “t-n” time, respectively. For example, the change in torque data may include a feature in which the friction coefficient between the disk and the pad is unstable as the change in torque applied to the braking device is large.

However, the variables included in the training input data 400 are not limited thereto. For example, a learning device may preprocess pieces of raw data associated with the braking device of the vehicle to obtain the training input data 400. Thus, for convenience of description in the specification, the variables included in the training input data 400 are mainly described as the variables shown in FIG. 4.

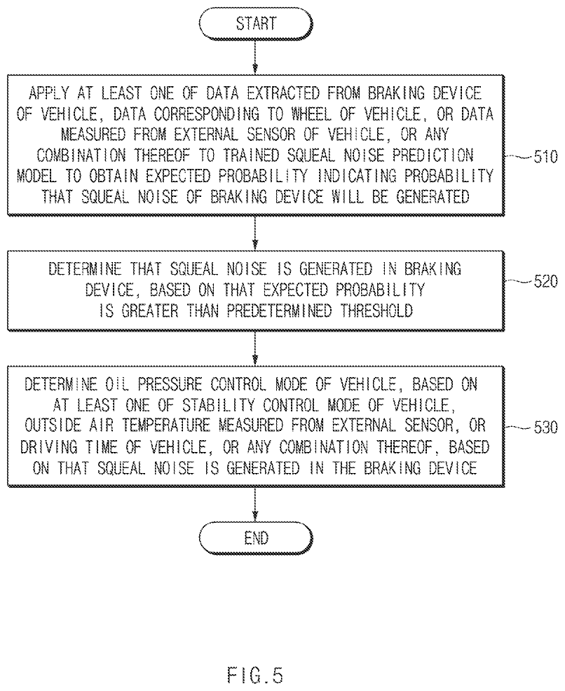

FIG. 5 is a flowchart for describing a method for predicting squeal noise by use of a trained squeal noise prediction model, in a squeal noise prediction device according to an embodiment of the present disclosure.

In operation 510, the squeal noise prediction device according to an embodiment may apply at least one of data extracted from a braking device of a vehicle, data corresponding to a wheel of the vehicle, data measured from an external sensor of the vehicle, or any combination thereof to a trained squeal noise prediction model (e.g., a squeal noise prediction model 350 of FIG. 3) to obtain an expected probability indicating a probability that squeal noise of the braking device will be generated.

For example, the squeal noise prediction device may include a processor and a memory including instructions. The processor may execute software and may control at least one other component (e.g., a hardware or software component connected with the processor. In addition, the processor may perform a variety of data processing or calculation. For example, the processor may store the data extracted from the braking device of the vehicle, the data corresponding to the wheel of the vehicle, the data measured from the external sensor of the vehicle, and the trained squeal noise prediction model in the memory. The memory may temporarily and/or permanently store various pieces of data and/or information required to infer the trained squeal noise prediction model.

In operation 520, the squeal noise prediction device may determine that the squeal noise is generated in the braking device, based on that the expected probability is greater than a predetermined threshold. For example, when the expected probability obtained from the trained squeal noise prediction model is greater than the threshold predetermined by a user, the squeal noise prediction device may determine that the squeal noise is generated in the braking device.

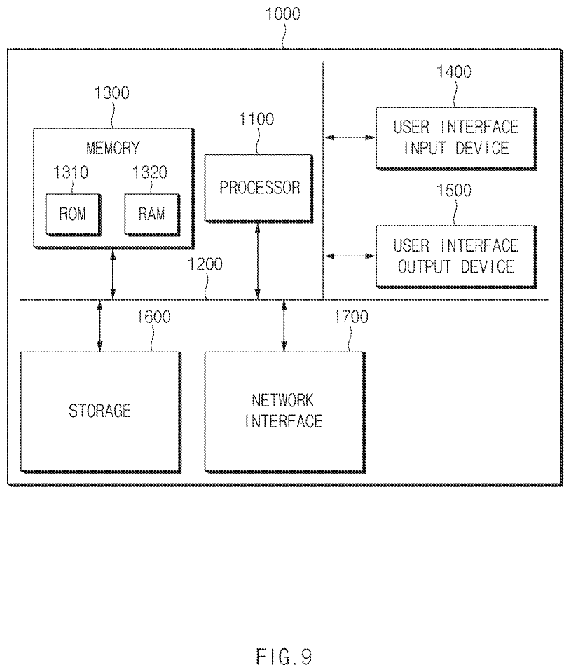

In operation 530, the squeal noise prediction device may determine an oil pressure control mode of the vehicle, based on at least one of a stability control mode of the vehicle, an outside air temperature measured from the external sensor, a driving time of the vehicle, or any combination thereof, based on that the squeal noise is generated in the braking device. For example, the oil pressure control mode may be a mode in which the amount of oil pressure applicable to the braking device is determined. A detailed description associated with it will be described below with reference to FIGS. 8 to 9.

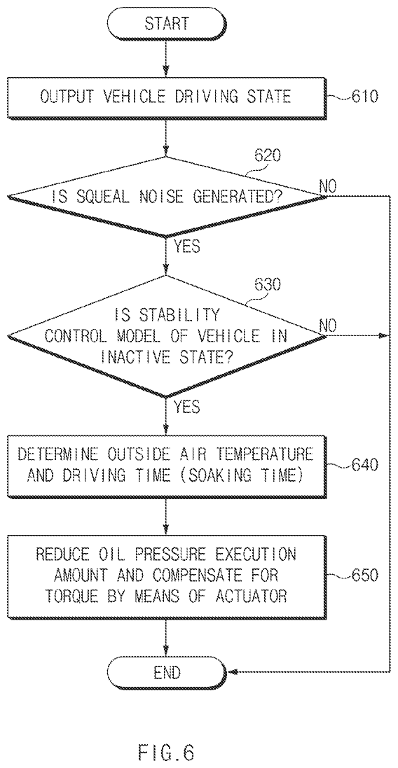

FIG. 6 is a flowchart for describing a method for determining a torque compensating amount, in a squeal noise prediction device according to an embodiment of the present disclosure.

In operation 610, the squeal noise prediction device may output a vehicle driving state. For example, the vehicle driving state may include data extracted from a braking device of a vehicle, data corresponding to a wheel of the vehicle, and data measured from an external sensor of the vehicle. The squeal noise prediction device may apply the output vehicle driving state to a trained squeal noise prediction model.

In operation 620, the squeal noise prediction device may determine whether squeal noise is generated. For example, the squeal noise prediction device may apply the output vehicle driving state to the trained squeal noise prediction model, thus obtaining an expected probability of squeal noise in the braking device. The squeal noise prediction device may determine that the squeal noise is generated in the braking device, based on that the expected probability is greater than a predetermined threshold. The squeal noise prediction device may perform the following operations, based on that the squeal noise is generated in the braking device.

In operation 630, the squeal noise prediction device may determine whether a stability control mode of the vehicle is in an inactive state. The squeal noise prediction device may perform the following operations, based on that the stability control mode of the vehicle is in the inactive state.

In operation 640, the squeal noise prediction device may obtain an outside air temperature measured from the external sensor and a driving time of the vehicle. As a result, in operation 650, the squeal noise prediction device may reduce an oil pressure execution amount and may compensate for a torque by use of an actuator. A detailed description associated with it will be given below with reference to FIG. 8.

FIG. 7 is a flowchart for describing a method for determining an oil pressure control mode, in a squeal noise prediction device according to an embodiment of the present disclosure.

The squeal noise prediction device according to an embodiment may determine an oil pressure control mode, based on a first sub-condition for comparing an outside air temperature with a first threshold and a second sub-condition for comparing a driving time with a second threshold, based on that a stability control mode is deactivated.

In operation 710, the squeal noise prediction device may compare the outside air temperature with the first threshold (e.g., shown as 0 degrees Celsius in FIG. 7). For example, when the outside air temperature is greater than or equal to the first threshold, in operation 720, the squeal noise prediction device may compare a driving time (e.g., shown as soaking time in FIG. 7) of a vehicle with a second threshold (e.g., shown as 2 hours in FIG. 7). When the outside air temperature is greater than or equal to the first threshold and the driving time of the vehicle is less than or equal to the second threshold, the squeal noise prediction device may determine the oil pressure control mode of a braking device as a third oil pressure control mode.

In operation 730, the squeal noise prediction device may determine the oil pressure control mode as a first oil pressure control mode, based on that the first sub-condition is met and the second sub-condition is met. Illustratively, the squeal noise prediction device may determine the oil pressure control mode as a second oil pressure control mode, based on that the first sub-condition is met and the second sub-condition is not met. Illustratively, the squeal noise prediction device may determine the oil pressure control mode as the third oil pressure control mode, based on that the first sub-condition is not met and the second sub-condition is not met.

For reference, for convenience of description in the specification, the first oil pressure control mode may indicate a mode for applying oil pressure reduced by 5 bar or more from oil pressure applied to the braking device to the braking device, the second oil pressure control mode may indicate a mode for applying oil pressure reduced by 3 bar or more and 5 bar or less from the oil pressure applied to the braking device to the braking device, and the third oil pressure control mode may indicate a mode for applying oil pressure reduced by 3 bar or less from the oil pressure applied to the braking device to the braking device.

FIG. 8 is a flowchart for describing a method for braking a vehicle, in a squeal noise prediction device according to an embodiment of the present disclosure.

In operation 810, the squeal noise prediction device according to an embodiment may determine an oil pressure control mode of a vehicle. For example, as described above with reference to FIG. 7, the squeal noise prediction device may determine the oil pressure control mode, based on the result of comparing the outside air temperature with the first threshold and comparing the driving time with the second threshold, based on that the stability control mode is deactivated.

In operation 820, the squeal noise prediction device may determine a torque compensating amount corresponding to the determined oil pressure control mode, based on an oil pressure decrease amount corresponding to the determined oil pressure control mode, a friction coefficient between a disk and a pad included in the braking device, and a piston area of the disk included in the braking device. For example, when the determined oil pressure control mode is a first oil pressure control mode, the squeal noise prediction device may determine a torque compensating amount corresponding to oil pressure reduced by 5 bar or more.

In operation 830, the squeal noise prediction device may generate a braking force lost by the oil pressure decrease amount to brake the vehicle. For example, the squeal noise prediction device may apply the determined torque compensating amount to at least one of a motor for generating a braking force through regenerative braking in the vehicle, a motor for generating a braking force by use of an electronic parking brake of the vehicle, a transmission for generating a braking force through an engine brake of the vehicle in the vehicle, or any combination thereof, thus generating a braking force lost by the oil pressure decrease amount to brake the vehicle.

FIG. 9 is a drawing illustrating a computing system associated with a learning device, a squeal noise prediction device, a learning method, and a squeal noise prediction method according to an embodiment of the present disclosure.

Referring to FIG. 9, a computing system 1000 about the learning device, the squeal noise prediction device, the learning method, and the squeal noise prediction method may include at least one processor 1100, a memory 1300, a user interface input device 1400, a user interface output device 1500, storage 1600, and a network interface 1700, which are connected with each other via a bus 1200, any combination of or all of which may be in plural or may include plural components thereof.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the example embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The example storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to example embodiments and the accompanying drawings, the present disclosure is not necessarily limited thereto, but may be variously modified and altered by those skilled in the art to which the present disclosure pertains without departing from the spirit and scope of the present disclosure claimed in the following claims.

The above-described example embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device that may execute instructions and respond. A processing unit may perform an operating system (OS) or a software application running on the OS. Further, the processing unit may access, store, manipulate, process and generate data in response to execution of software. It can be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor, together or distributed.

Software may include computer programs, codes, instructions or one or more combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one computer-readable storage media.

The methods according to embodiments may be implemented in the form of program instructions that may be executed through various computer systems and may be recorded in computer-readable media. The computer-readable media may include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The above-described hardware devices may be configured to act as one or a plurality of software modules to perform the operations of the embodiments, or vice versa.

Even though the example embodiments are described with reference to restricted drawings, it may be clear to one skilled in the art that embodiments can be variously changed or modified based on the above description. For example, adequate effects may be achieved even if the foregoing processes and methods are carried out in different order than described above, and/or the aforementioned components, such as systems, structures, devices, or circuits, are combined or coupled in different forms and modes than as described above or be substituted or switched with other components or equivalents.

A description will be given below of advantages of the learning device, the squeal noise prediction device, the learning method, and the squeal noise prediction method according to an embodiment of the present disclosure.

According to at least one of embodiments of the present disclosure, the learning device may train a squeal noise prediction model based on training input data generated through preprocessing of first raw data, second raw data, and third raw data, thus reflecting a relation between a rapid change in friction coefficient between the disk and the pad and a torque estimate in the squeal noise prediction model.

According to at least one of embodiments of the present disclosure, the learning device may train the squeal noise prediction model based on a first loss function associated with regression or a second loss function associated with classification, thus increasing the satisfaction of the user by use of the squeal noise prediction model with better performance than training the squeal noise prediction model using one loss function.

According to at least one of embodiments of the present disclosure, the learning device may perform online learning of the squeal noise prediction model using the obtained data after training the squeal noise prediction model, thus reducing squeal noise capable of being generated from the braking device that is aging according to a usage condition of the user.

Other implements, other embodiments, and equivalents to claims are within the scope of the following claims.

Therefore, the example embodiments of the present disclosure are not intended to limit the technical spirit of the present disclosure, but are provided illustrative purposes. The scope of the present disclosure can be construed on the basis of the accompanying claims, and technical ideas within the scope equivalent to the claims can be included in the scope of the present disclosure.

What is claimed is:

1. A learning device comprising:
one or more processors; and
a non-transitory storage medium storing computer-readable instructions that, when executed by the one or more processors, enable the one or more processors to:
preprocess one of or any combination of first raw data extracted from a braking device of a vehicle, second raw data including wheel data associated with a wheel of the vehicle, and third raw data measured from an external sensor of the vehicle, to obtain training input data at a target time point at which the braking device operates,
apply the training input data and target data corresponding to squeal noise generated by the training input data, to a squeal noise prediction model to obtain temporary output data, and
train the squeal noise prediction model, based on a first loss value obtained by applying the temporary output data and the target data to a first loss function associated with regression.

2. The learning device of claim 1, wherein the instructions further enable the one or more processors to:
generate the first raw data including at least one of or any combination of oil pressure data associated with oil pressure applied to the braking device, disk temperature data, and torque data associated with a torque applied to a disk included in the braking device;
generate the second raw data, including at least one of or both of wheel speed data associated with a speed of the wheel and rolling circumference data of a tire combined with the wheel, at the target time point; and
generate the third raw data, including at least one of or both of outside air temperature data from the external sensor and humidity data from the external sensor, at the target time point.

3. The learning device of claim 2, wherein the instructions further enable the one or more processors to:
generate first sub-input data including a first square of the disk temperature data and a second square of the wheel speed data;
generate second sub-input data including a first change in the wheel speed data at the target time point and at a subsequent time point, the subsequent time point being subsequent to the target time point, a second change in the disk temperature data at the target time point and at the subsequent time point, a third change in the oil pressure data at the target time point and at the subsequent time point, and a fourth change in the torque data at the target time point and at the subsequent time point;
generate third sub-input data including first torque estimation data generated based on the first change in the wheel speed data, and second torque estimation data generated based on the first torque estimation data and the disk temperature data; and
bind the first sub-input data, the second sub-input data, and the third sub-input data to obtain the training input data.

4. The learning device of claim 1, wherein the instructions further enable the one or more processors to train the squeal noise prediction model, based on a second loss value obtained by applying the temporary output data and the target data to a second loss function associated with classification.

5. The learning device of claim 4, wherein the instructions further enable the one or more processors to:
determine a classification class of the training input data, based on a comparison between the temporary output data and a predetermined threshold; and
train the squeal noise prediction model, based on a second loss value obtained by applying the classification class and the target data to the second loss function.

6. A squeal noise prediction device, comprising:
one or more processors; and
a non-transitory storage medium storing computer-readable instructions that, when executed by the one or more processors, enable the one or more processors to:
apply one of or any combination of braking data extracted from a braking device of a vehicle, wheel data corresponding to a wheel of the vehicle, and external sensor data measured from an external sensor of the vehicle, to a trained squeal noise prediction model to obtain an expected probability indicating a probability that squeal noise of the braking device will be generated,
determine that the squeal noise is generated in the braking device, based on the expected probability being greater than a predetermined threshold, and
determine an oil pressure control mode of the vehicle, based on one of or any combination of a stability control mode of the vehicle, an outside air temperature measured from the external sensor, and a driving time of the vehicle, based on that the squeal noise is generated in the braking device.

7. The squeal noise prediction device of claim 6, wherein the instructions further enable the one or more processors to determine the oil pressure control mode, based on a first sub-condition for comparing the outside air temperature with a first threshold, based on a second sub-condition for comparing the driving time with a second threshold, and based on that the stability control mode is deactivated.

8. The squeal noise prediction device of claim 7, wherein the instructions further enable the one or more processors to:
determine the oil pressure control mode as a first oil pressure control mode, based on the first sub-condition being met and the second sub-condition being met;
determine the oil pressure control mode as a second oil pressure control mode, based on the first sub-condition being met and the second sub-condition being not met; and
determine the oil pressure control mode as a third oil pressure control mode, based on the first sub-condition being not met and the second sub-condition being not met.

9. The squeal noise prediction device of claim 7, wherein the instructions further enable the one or more processors to determine a torque compensating amount corresponding to the determined oil pressure control mode, based on an oil pressure decrease amount corresponding to the determined oil pressure control mode, a friction coefficient between a disk and a pad included in the braking device, and a piston area of the disk included in the braking device.

10. The squeal noise prediction device of claim 9, wherein the instructions further enable the one or more processors to apply the torque compensating amount to one of or any combination of a regenerative braking motor for generating a regenerative braking force through regenerative braking in the vehicle, an electronic parking brake motor for generating an electronic parking braking force by an electronic parking brake of the vehicle, or a transmission for generating a transmission braking force by an engine brake of the vehicle, to generate a compensating braking force lost by the oil pressure decrease amount to brake the vehicle.

11. A learning method, comprising:
preprocessing one of or any combination of first raw data extracted from a braking device of a vehicle, second raw data including wheel data associated with a wheel of the vehicle, and third raw data measured from an external sensor of the vehicle, to obtain training input data at a target time point at which the braking device operates;
applying the training input data and target data corresponding to squeal noise generated by the training input data, to a squeal noise prediction model to obtain temporary output data; and
training the squeal noise prediction model, based on a first loss value obtained by applying the temporary output data and the target data to a first loss function associated with regression.

12. The learning method of claim 11, wherein the obtaining of the training input data includes:
generating the first raw data including one of or any combination of oil pressure data associated with oil pressure applied to the braking device, disk temperature data, and torque data associated with a torque applied to a disk included in the braking device;
generating the second raw data, including one of or both of wheel speed data associated with a speed of the wheel and rolling circumference data of a tire combined with the wheel, at the target time point; and
generating the third raw data, including one of or both of outside air temperature data from the external sensor and humidity data from the external sensor, at the target time point.

13. The learning method of claim 12, further comprising:
generating first sub-input data including a first square of the disk temperature data and a second square of the wheel speed data;
generating second sub-input data including a first change in the wheel speed data at the target time point and at a subsequent time point, the subsequent time point being subsequent to the target time point, a second change in the disk temperature data at the target time point and at the subsequent time point, a third change in the oil pressure data at the target time point and at the subsequent time point, and a fourth change in the torque data at the target time point and at the subsequent time point;
generating a third sub-input data including first torque estimation data generated based on the first change in the wheel speed data, and second torque estimation data generated based on the first torque estimation data and the disk temperature data; and
binding the first sub-input data, the second sub-input data, and the third sub-input data to obtain the training input data.

14. The learning method of claim 11, wherein the training of the squeal noise prediction model comprises training the squeal noise prediction model based on a second loss value obtained by applying the temporary output data and the target data to a second loss function associated with classification.

15. The learning method of claim 14, wherein the training of the squeal noise prediction model further comprises:
determining a classification class of the training input data, based on a comparison between the temporary output data and a predetermined threshold; and
training the squeal noise prediction model, based on a second loss value obtained by applying the classification class and the target data to the second loss function.

16. A squeal noise prediction method, comprising:
applying one of or any combination of braking data extracted from a braking device of a vehicle, wheel data corresponding to a wheel of the vehicle, and external sensor data measured from an external sensor of the vehicle, to a trained squeal noise prediction model to obtain an expected probability indicating a probability that squeal noise of the braking device will be generated;
determining that the squeal noise is generated in the braking device, based on the expected probability being greater than a predetermined threshold; and
determining an oil pressure control mode of the vehicle, based one of or any combination of a stability control mode of the vehicle, an outside air temperature measured from the external sensor, and a driving time of the vehicle, based on that the squeal noise is generated in the braking device.

17. The squeal noise prediction method of claim 16, wherein the determining of the oil pressure control mode of the vehicle comprises determining the oil pressure control mode based on a first sub-condition for comparing the outside air temperature with a first threshold, based on a second sub-condition for comparing the driving time with a second threshold, and based on the stability control mode being deactivated.

18. The squeal noise prediction method of claim 17, wherein the determining of the oil pressure control mode of the vehicle further comprises:
determining the oil pressure control mode as a first oil pressure control mode, based on the first sub-condition being met and the second sub-condition being met;
determining the oil pressure control mode as a second oil pressure control mode, based on the first sub-condition being met and the second sub-condition being not met; and
determining the oil pressure control mode as a third oil pressure control mode, based on the first sub-condition being not met and the second sub-condition being not met.

19. The squeal noise prediction method of claim 17, further comprising determining a torque compensating amount corresponding to the determined oil pressure control mode, based on an oil pressure decrease amount corresponding to the determined oil pressure control mode, a friction coefficient between a disk and a pad included in the braking device, and a piston area of the disk included in the braking device.

20. The squeal noise prediction method of claim 19, further comprising applying the torque compensating amount to one of or any combination of a regenerative braking motor for generating a regenerative braking force through regenerative braking in the vehicle, an electronic parking brake motor for generating an electronic parking braking force by an electronic parking brake of the vehicle, or a transmission for generating a transmission braking force by an engine brake of the vehicle in the vehicle, to generate a compensating braking force lost by the oil pressure decrease amount to brake the vehicle.
